(19) United States
(12) Patent Application Publication
(10) Pub. No.: US 2018/0308076 A1
(43) Pub. Date: Oct. 25, 2018

(54) ELECTRONIC FINANCIAL PROCESSING SYSTEM USING PERSONAL ATM TERMINAL AND METHOD FOR PROCESSING THEREOF

(71) Applicant: JINI CO., LTD, Jeollabuk-do (KR)

(72) Inventor: Hye Jin JEONG, Jeollabuk-do (KR)

(73) Assignee: JINI CO., LTD, Jeollabuk-do (KR)

(21) Appl. No.: 15/576,787

(22) PCT Filed: Sep. 12, 2016
(86) PCT No.: PCT/KR2016/010237

§ 371 Date: Nov. 24, 2017

(30) Foreign Application Priority Data
Sep. 17, 2015 (KR) 10-2015-0131733

(51) Int. Cl. G06Q 20/10; G06Q 20/32; G06Q 20/34; G06Q 20/38

(52) U.S. Cl. CPC G06Q 20/1085; G06Q 20/3821; G06Q 20/341; G06Q 20/3226

(57) ABSTRACT

An electronic financial processing system using a personal ATM terminal and a method for processing thereof. The electronic financial processing system verifies the identity of the user and the password of the card by using a communication device capable of communicating with the personal ATM terminal, for example, a smart phone. A personal ATM terminal is connected to a smart phone via a wired or wireless communication. The personal ATM terminal can read the biometric information and the card information of the user. Accordingly, the personal ATM terminal processes various electronic financial services such as transfer, payment, cash withdrawal, or etc. providing a financial safety in an electronic financial transaction.

### TECHNICAL FIELD

The present invention relates to an electronic financial processing system, and more particularly, to an electronic financial processing system and its method using a personal finance ATM (Automated Teller Machine) that processes electronic financial transactions with a financial safety by preventing various types of information leaks and preventing, in advance, accidents in financial transactions.

### BACKGROUND ART

The introduction of Automated Teller Machine (ATM) in the traditional financial transactions, which was carried out by the financial institution in direct contact with the manager, brought about innovative development in several respects. For example, as financial customers may conduct financial transactions through ATM devices without going through bank accounts, latency for financial transactions has been significantly reduced and financial transactions can be made even after the end of financial services.

ATM devices basically carry out many financial operations performed by financial institutions, such as account transfer, balance inquiry, deposit withdrawal, and account book collection. Because of these advantages of ATM devices, the number of installed ATM devices and its users are rapidly increasing. Today, ATM devices can be easily found everywhere.

However, when transferring money from an ATM device, the customer inserts the bank card or bankbook of the withdrawal account into the ATM device, and then the customer inputs the deposit account number and the password directly. Therefore, it may cause an error in inputting a bank account number, a password leak may occur, and this may be abused by a crime. Accordingly, considering that ATM equipment handles customers' financial transaction information, it is necessary to let customers safely use the ATM without concerning such a problem.

These ATM devices are generally fixed at its installation site, so customers can use the ATM only when they visit the installation site. If it is a late time for the customer to use ATM equipment or it is a lonesome place where ATM is installed, there is a possibility of a serious crime. In addition, when the customer, to withdraw cash, inserts a card into an ATM device which uses a smart device, an accident could occur, for example, the card information and the password may be stolen. Further, ATM is generally operated on the basis of Microsoft Window, and the Coroner's Toolkit (TCT) or User Datagram Protocol (UDP) communication is performed in ATM, so it requires inevitably a regular security management.

### RELATED ART DOCUMENTS

Patent Document 1: Korean patent Application Laid-Open Publication No. 10-2012-0040502 (publication date: Apr. 27, 2012)

Patent Document 2: Korean Patent No. 10-1499504 (Issue date: Mar. 6, 2015)

Patent Document 3: Korean patent Application Laid-Open Publication No. 10-2012-0107647 (publication date: Oct. 4, 2012)

Patent Document 4: Korean patent Application Laid-Open Publication No. 10-2011-0019526 (publication date: Feb. 28, 2011)

### DISCLOSURE OF INVENTION

### Technical Problem

An object of the present invention is to provide an electronic financial transaction system and a processing method thereof, for a safe electronic financial service, using an electronic device capable of communicating with a personal ATM terminal.

Another object of the present invention is to provide the system and its method which prevents leakage of card information and personal information of a user by using a personal ATM terminal.

### Technical Solution

In order to achieve the above objects, an electronic financial transaction system of the present invention is characterized in that an electronic financial service is performed by using a personal ATM device and a smart phone together. Such an electronic financial processing system prevents various information leaks and prevents accidents caused by financial transactions, thereby handling electronic financial transactions with safety.

According to the aspect of the present invention, the method of electronic financial processing for the electronic financial processing includes: recognizing the biometric information of the user; verifying, by the personal ATM terminal, the identity of the user by comparing the recognized biometric information of the user with the stored biometric information; reading, by the personal ATM terminal, if the recognized biometric information matches the stored biometric information, the card information of the electronic financial card; receiving, by the communication device, the electronic financial transaction information required for the electronic financial service from the user; transmitting, by the communication device, the electronic financial transaction information to the personal ATM terminal; encrypting, by the personal ATM terminal, the electronic financial transaction information and the card information; transmitting, by the personal ATM terminal, the encrypted electronic financial transaction information and the encrypted card information to the communication device; requesting, by the communication device, the electronic financial service to the financial institution server by transmitting the encrypted electronic financial transaction information and the encrypted card information to the financial institution server; approving, by the financial institution server, the electronic financial service requested by the communication device.

According to an exemplary embodiment of the aspect, when requesting the electronic financial service, at least one of the card information and the electronic financial transaction information for the requested electronic financial service is encrypted by the personal ATM terminal, and at least one of the card information and the electronic financial transaction information is decrypted by the financial institution server.

In another exemplary embodiment of the aspect, the method further includes: identifying, by the personal ATM terminal, a financial institution from the read card information; generating, by the personal ATM terminal, a card information data through assigning a financial institution code to the read card information wherein the financial institution code corresponds to the identified financial institution; and transmitting, by the personal ATM terminal, the card information data to the communication device so that the communication device requests the electronic financial service.

According to another aspect of the present invention, a method of an electronic financial processing system which includes a personal ATM terminal and a communication device is provided.

According to the another aspect of the present invention, the system includes: the method includes: reading, by a personal ATM terminal, a card information from an electronic financial card of a user; transmitting, by a personal ATM terminal, the read card information to a communication device; checking, by the communication device, if a case is purchasing or selling; if the case is the purchasing, receiving, by the communication device, a purchase billing information, verifying, by the personal ATM terminal, an identity of the user or a validity of the electronic financial card by using a biometric information of the user or a password of the read card information, transmitting, by the personal ATM terminal, the card information and the purchase billing information to the communication device, requesting, by the communication device, a payment approval to a financial institution server with the card information and the purchase billing information; If the case is the selling, receiving, by the communication device, a sale billing information, transmitting, by the personal ATM terminal, the card information and the sale billing information to the communication device, requesting, by the communication device, a payment approval to the financial institution server with the card information and the sale billing information; and approving, by the financial institution server, the payment with the purchase billing information or the sale billing information.

According to an exemplary embodiment of the another aspect, the method further includes: receiving, by the communication device, when the card information is transmitted from the personal ATM terminal, the card information, receiving, by the communication device, at least one of a cash transfer information and a cash withdrawal information from the user; transmitting, by the communication device, the card information and at least one of the cash transfer information and the cash withdrawal information to an ATM device for a cash withdrawal connected with the financial institution server; transmitting, by the ATM device for a cash withdrawal, the card information and at least one of the cash transfer information and the cash withdrawal information to the financial institution server with requesting at least one of a cash transfer and a cash withdrawal to the financial institution server; processing, by the financial institution server, a verification of at least one of the requested cash transfer and the requested cash withdrawal; allowing, by the financial institution server, if the verification is successful for the requested cash withdrawal, the user to withdraw a cash from the ATM device according to the cash withdrawal information; processing, by the financial institution server, if the verification is successful for the requested cash transfer, the requested cash transfer according to the cash transfer information; and saving, by at least one of the ATM device and the financial institution server, at least one of a cash withdrawal result or a cash transfer result.

### Advantageous Effects

As described above, the electronic financial transaction system of the present invention can provide an electronic financial transaction secured with safety through verifying user identity and card information by using a personal ATM terminal and a smart phone and requesting a variety of electronic financial services to prevent various information leaks and prevent accidents due to financial transactions.

Also, the electronic financial transaction system of the present invention can provide an effect of securing safety and reducing a fee for payment processing, as compared with existing electronic financial service relaying electronic banking services through the PG (pay gate) or VAN (value added network) system which is generally provided among smart phones and servers of financial institutes because the personal ATM terminal includes the functions of PG or VAN system.

Further, the electronic financial transaction system of the present invention can minimize an accident that the user's card information and password are hacked through verifying the user identity and the card information by using the personal ATM terminal and the smart phone.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram showing a configuration of an electronic financial transaction system according to an embodiment of the present invention;

FIG. 2 is a block diagram showing the configuration of the personal ATM terminal shown in FIG. 1 according to an embodiment of the present invention;

FIG. 3 is a flowchart showing a procedure for remitting an electronic financial service by using biometric information of an electronic financial transaction system according to the first embodiment of the present invention;

FIG. 4 is a flowchart illustrating a procedure for remitting an electronic financial service by using card information in an electronic financial processing system according to a second embodiment of the present invention;

FIG. 5 is a flowchart illustrating a procedure for processing a PG/VAN function of an electronic financial service by using a personal ATM terminal of an electronic financial transaction processing system according to a third embodiment of the present invention;

FIG. 6A is a diagram showing the data structure of the card information shown in FIG. 5;

FIG. 6B is another diagram showing the data structure of the card information shown in FIG. 5;

FIG. 7 is a flowchart illustrating a processing procedure of an electronic financial service for purchasing and selling goods in the electronic financial transaction system according to the fourth embodiment of the present invention; and

FIG. 8 is a flowchart illustrating a procedure for processing transfer and cash withdrawal of an electronic financial service using a personal ATM terminal of an electronic financial transaction processing system according to a fifth embodiment of the present invention.

### DETAILED DESCRIPTION

Exemplary embodiments of the present invention can have other modifications and variations, and the scope of this present invention should not be limited by the embodiments described below. These exemplary embodiments of the present invention are provided in order to better explain the present invention to others skilled in the art. Thus, the some of elements of the drawing are exaggerated in their shape for a clear explanation.

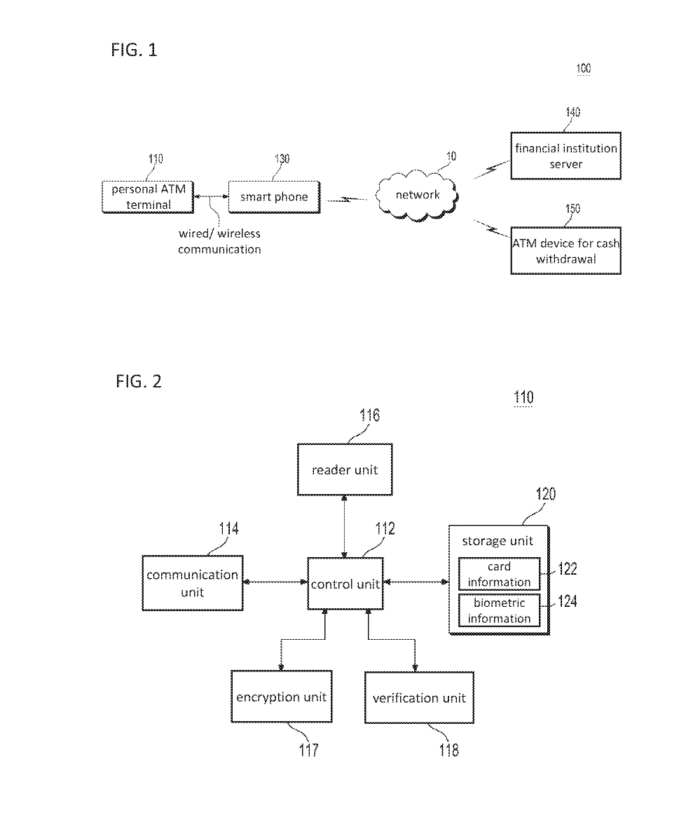

Hereinafter, embodiments of the present invention will be described in detail with reference to FIG. 1 to FIG. 8.

FIG. 1 is a block diagram showing the configuration of an electronic financial transaction system according to the present invention, and FIG. 2 is a block diagram showing the configuration of the personal finance automated terminal shown in FIG. 1.

Referring to FIGS. 1 and 2, the electronic financial transaction processing system 100 of the present invention may process electronic financial services such as card payments, account transfer and cash withdrawal by using an electronic device capable of communicating via a wired/wireless communication such as a smart phone 130, a personal ATM terminal 110 capable of reading an electronic financial card.

Specifically, the electronic financial transaction processing system 100 of the present invention may include the personal ATM terminal 110, the smart phone 130, and a financial institution server 140. The electronic financial transaction system 100 may further include an ATM device 150 for cash withdrawal.

The personal ATM terminal 110 may be wired or wirelessly connected to the smart phone 130, be capable of reading an electronic financial card, recognize biometric information of a user such as a fingerprint, an iris, or etc., and process the verification of the validity of the user's identity by using card's passwords or the biometric information. The personal ATM terminal 110 may encrypt data to be transmitted to the smartphone 130. The personal ATM terminal 110 may be registered and managed in the financial institution server 140.

The personal ATM terminal 110 of this embodiment may include a communication unit 114, a reader unit 116, an encryption unit 117, a verification unit 118, a storage unit 120, control unit 112.

The communication unit 114 may transmit data to the smartphone 130 via wired or wireless communication. The reader unit 116 may reads card information from an IC card such as a credit card, a check card and an ID card of a user who is requesting an electronic financial service, or read biometric information such as a fingerprint, an iris, or etc. The encryption unit 117 may encrypt the data to be transmitted to the smartphone 130. The verification unit 118 may verify the user's personal identity and the validity of the IC card. The storage unit 120 may store the card information 122 and the biometric information 124. The storage unit 120 may further store the account information corresponding to the read card information.

The control unit 112 may control the personal ATM terminal 110 to process all the operations of the personal ATM terminal 110. That is, the control unit 114 may control the communication unit 114, the reader unit 116, the encryption unit 117, the verification unit 118, and the storage unit 120, and verify the user identity and card validity by recognizing the password and biometric information for the electronic financial service between the financial institution server 140 and the ATM device 150 for cash withdrawal through the smartphone 130 to process the electronic financial service.

Such a personal ATM terminal 110 may be installed in the smart phone 130, or when performing cash transfer or remittance using the wireless communication, the personal ATM terminal 110, after confirming the identity of requester, may request the cash transfer or remittance to the financial institution server 140 through the smart phone 130. At this time, the verifying the identity may be performed by recognizing the biometric information and comparing it with the biometric information stored in the storage unit 120, or receiving input of the password of the IC card and processing the password.

In the case of cash service or cash withdrawal, the personal ATM terminal 110, after confirming the identity, may request the cash withdrawal to the cash withdrawal ATM device 150 through the smart phone 130. At this time, the personal ATM terminal 110 may recognize the biometric information and compare it with the biometric information stored in the storage unit 120, or receive input of the password of the IC card to process the identity verification.

The smart phone 130 may be an electronic device capable of performing wired/wireless communication with the financial institution server 140 and the cash withdrawing ATM device 150. The smart phone 130 may use an application (not shown in drawings) to input information necessary for the electronic financial service, such as transfer information, password, payment information, and the like, and output the result of the electronic financial service request. In this embodiment, data for the electronic financial service is transmitted between the personal ATM terminal 110 and the financial institution server 140, or between the personal ATM terminal 110 and the cash withdrawable ATM devices 150 using the smart phone 130, but the present invention can be applied to various electronic apparatuses (for example, a personal computer, a tablet PC, etc.) that can communicate instead of the smart phone 130.

The financial institution server 140 may be provided in, for example, a credit card company, a bank company, or etc., register and manage the personal ATM terminal 110 and provide an electronic financial service for transfer, remittance, payment, cash withdrawal, or etc. The description of the financial institution server 140 is well known in the art, so that a detailed description thereof is omitted.

When the personal ATM terminal 110 requests the cash withdrawal through the smart phone 130, the ATM device 150 for cash withdrawal may process cash to be withdrawn in cooperation with the financial institution server 140. The ATM device 150 for cash withdrawal may be fixedly installed in a specific place and store cash. The description of the ATM device 150 for cash withdrawal is well known in the art, so that a detailed description thereof is omitted.

As described above, the electronic financial transaction processing system 100 of the present invention may verify the identity of a user using a personal ATM terminal 110 that transmits data to a communicable electronic device such as a smart phone 130, read card information, and request various electronic financial services. Therefore, the electronic financial transaction processing system 100 of the present invention can provide electronic financial transaction with securing safety.

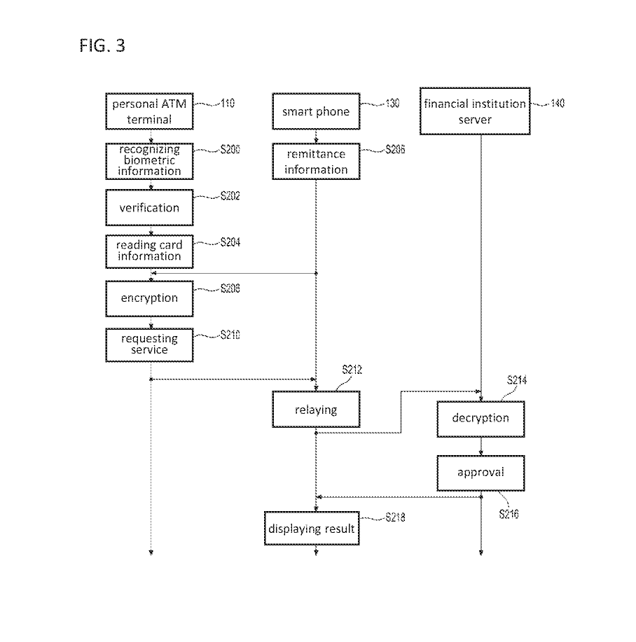

Next, processing procedures for the electronic financial service of the electronic financial processing system are described in detail with reference to FIGS. 3 to 8.

FIG. 3 is a flowchart showing a remittance processing procedure of an electronic financial service by using biometric information in the electronic financial processing system according to the first embodiment of the present invention.

Referring to FIG. 3, the electronic financial transaction system 100 of this embodiment may process the remittance process of the electronic financial service after confirming the identity using the biometric information. In step S200, the personal ATM terminal 110 may read or recognize the biometric information of the user by the reader 116, and, in step S202, may verify the user's identity by matching the recognized biometric information with a certain user and comparing the recognized biometric information with the biometric information 124 stored in the storage unit 120 with the user in step S202. That is, if the biometric information recognized by the reader unit 116 matches the biometric information 124 stored in the storage unit 120, the procedure goes to step S204, and the card information of the user is read through the reader unit 116. However, if the verification fails, the procedure ends.

In step S206, the user inputs the remittance information, for example, the name of the remitter, the account number, the amount to be remitted, and the like, through the smart phone 130, and transmits the remittance information to the personal ATM terminal 110.

In step S208, the personal ATM terminal 110 encrypts the remittance information and the read card information transmitted from the smartphone 130 through the encryption unit 117. In step S210, the personal ATM terminal 110 requests an electronic financial service, the transfer money.

In step S212, the smart phone 130 relays the encrypted data from the personal ATM terminal 110 to the financial institution server 140.

In step S214, the financial institution server 140 receives and decrypts the encrypted data transmitted from the smart phone 130, and in step S216, processes approval and remittance of the remittance request. In step S218, the smart phone 130 receives the result of the remittance process from the financial institution server 140 and displays it on a display device (not shown in the drawings).

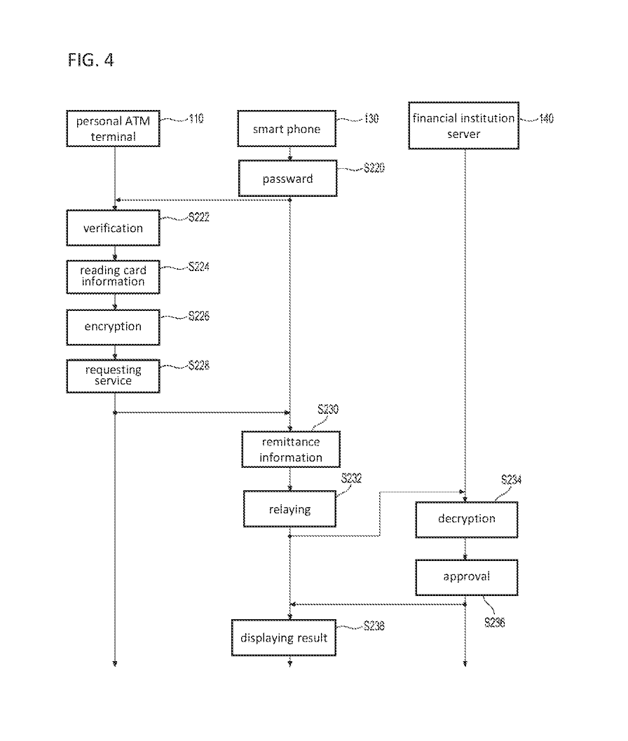

FIG. 4 is a flowchart showing a remittance processing procedure of an electronic financial service using card information in the electronic financial transaction system according to the second embodiment of the present invention.

Referring to FIG. 4, the electronic financial transaction system 100 of this embodiment processes the remittance process of the electronic financial service after confirming the identity using the card. When the card is inserted into the personal ATM terminal 110, the smart phone 130 receives the password of the user, and the smart phone 130 transmits the password to the personal ATM terminal 110.

In step S222, the personal ATM terminal 110 verifies the password of the inserted card, and if the verification is successful in step S224, reads the card information. If the password verification fails, the procedure ends.

In step S226, the personal ATM terminal 110 encrypts the read card information, and in step S228 requests the electronic financial service to the smart phone 130, such as a transfer service.

In step S230, the smart phone 130 inputs remittance information, for example, the name of the remitter, the account number and the amount to be remitted when the remittance request is transmitted from the personal ATM terminal, and relays the encrypted card information transmitted from the personal ATM terminal (110) to the financial institution server (140).

In step S234, the financial institution server 140 decrypts the card information after receiving the encrypted card information and the remittance information transmitted from the smart phone 130, and processes the approval and remittance of the remittance request in step S236. Then, in step S238, the smart phone 130 receives the result of the remittance process from the financial institution server 140 and displays it on the display device.

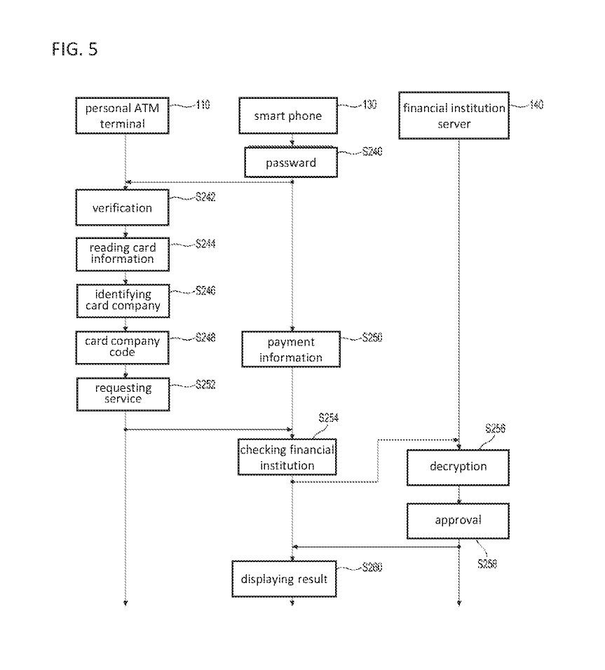

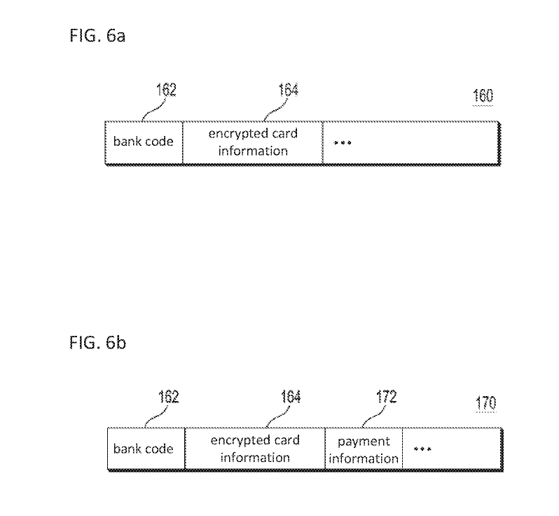

FIG. 5 is a flowcharts of an electronic financial processing system illustrating a procedure of processing PG/VAN functions of an electronic financial service using a personal ATM terminal according to a third embodiment of the present invention. FIGS. 6A and 6B are diagrams showing a data structure of the card information shown in FIG. 5.

Referring to FIG. 5, the electronic financial transaction system 100 of this embodiment is for payment processing, and the personal ATM terminal 110 processes the function of a pay gate (PG) or a value added network (VAN) system.

When the card is inserted into the personal ATM terminal 110, the electronic banking processing system 100 receives the password and transmits the password to the personal ATM terminal 110 in step S240. Here, the smartphone 130 is provided as a smartphone of a buyer or a seller. That is, in the case of a smartphone of a buyer, the personal ATM terminal 110 processes the functions of the PG system, and in the case of a smartphone of a seller, the personal ATM terminal 110 processes the functions of the VAN system.

In step S242, the personal ATM terminal 110 verifies the password of the inserted card, and if the verification is successful in step S244, the card information is read. If the password verification fails, the procedure ends.

In step S246, the personal ATM terminal 110 identifies the card company from the read card information. A card company code corresponding to the card company identified in step S248 is given to the card information to generate card information data. In this embodiment, the card information data 160 has a data structure including a bank (or card company) code field 162 and an encrypted card information field 164, as shown in FIG. 6A.

In step S252, the personal ATM terminal 110 transmits the card information data 160 which includes the card company code to the smart phone 130 to request the electronic financial service such as requesting payment approval.

At this time, in step S250, the smartphone 130 receives payment information, for example, an amount to be paid, a name of the person to be paid, an account number, or etc.

In step S254, the smart phone 130 checks a financial institution (a bank or a card company) from the card information data 160 transmitted from the personal ATM terminal 110, and transmits the card information data including the encrypted card information and the payment information 170 to the financial institution server 140. Here, the card information data 170 has a data structure including a bank (or card company) code field 162, an encrypted card information field 164, and payment information 172, as shown in FIG. 6B.

In step S256, the financial institution server 140 receives and decrypts the card information data 170 transmitted from the smartphone 130, and in step S258 processes approval and payment for the requested payment. Then, in step S260, the smart phone 130 receives the payment processing result from the financial institution server 140 and displays it on the display device.

In this embodiment, a personal ATM terminal processes a function of a pay gate (PG) system or a VAN (Value Added Network) system to provide an effect of securing safety and reducing a fee for settlement processing as compared with relay processing of an electronic financial service which provides the PG or VAN system between a smartphone and financial institution servers.

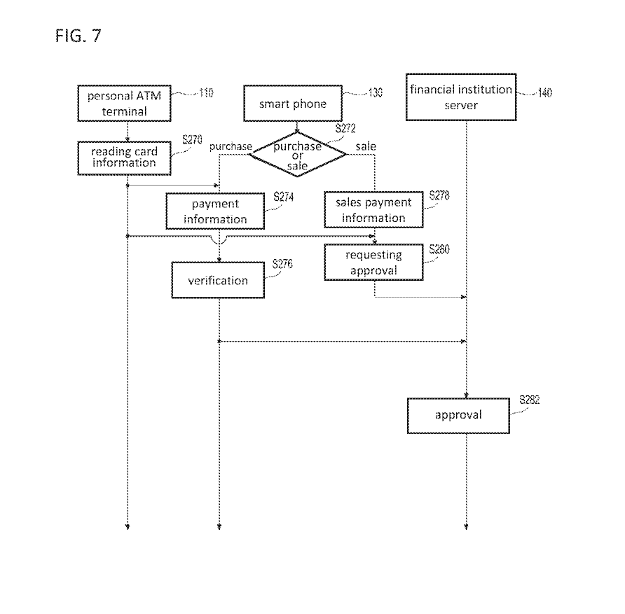

FIG. 7 is a flowchart showing a processing procedure of an electronic financial service for purchasing and selling goods in the electronic financial transaction system according to the fourth embodiment of the present invention.

Referring to FIG. 7, the electronic financial transaction system 100 of this embodiment processes an electronic financial service when purchasing or selling a product using a personal ATM terminal 110, and can process payments for purchase and sale by using one personal ATM terminal 110.

That is, in step S270, the electronic financial transaction processing system 100 reads the card information by the personal ATM terminal 110 and transmits the read card information to the smart phone 130.

In step S272, when the smart card 130 transmits the card information, it determines whether it is a purchase or sale. That is, it is determined whether the user of the smartphone 130 is a buyer or a seller.

If it is determined as a purchase, the purchase payment information is input in step S274. In step S276, the card information is verified by using the biometric information or the password, and the card information and the purchase payment information are transmitted to the financial institution server with requesting a payment approval.

As a result of the determination, if it is a sale, the smartphone 130 receives sales payment information in step S278, and requests a payment approval to the financial institution server in step S280.

Then, in step S282, the financial institution server 140 receives purchase payment information or sales payment information from the smartphone 130, and processes the approval of the payment.

In this embodiment, the smart phone 130 transmits purchase payment information or sales payment information to the financial institution server 140. However, instead of the financial institution server 140, via an agent system such as a PG or a VAN system, the purchase or payment authorization may be requested.

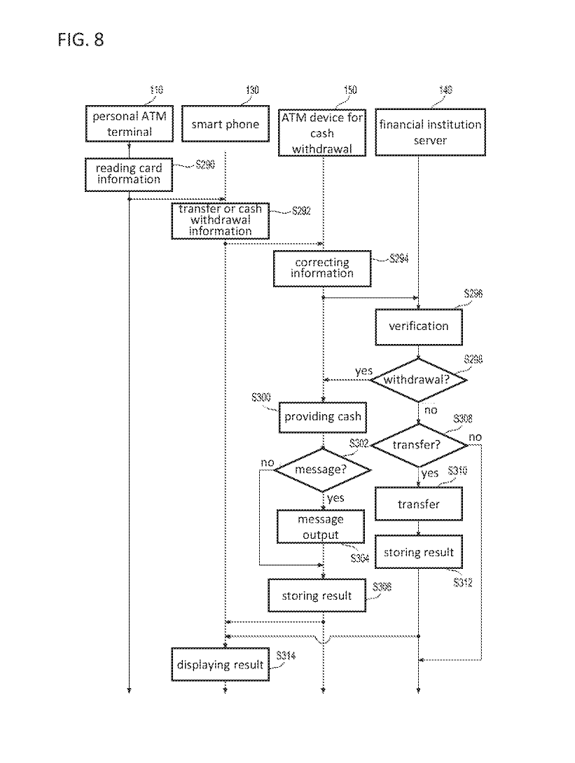

FIG. 8 is a flowchart illustrating a procedure for processing transfer and cash withdrawal of an electronic financial service using a personal ATM terminal of the electronic financial transaction processing system according to the fifth embodiment of the present invention.

Referring to FIG. 8, the electronic financial transaction system 100 of the present embodiment processes an electronic financial service such as cash withdrawal and transfer using a personal ATM terminal 110, and, to that end, a smart phone 130, a cash withdrawal ATM device 150 and the financial institution server 140 are interoperable with each other. Here, the ATM device 150 for cash withdrawal may include only a cash storage for storing cash, a printer, and a communication device without an input device and a display device for an electronic financial service.

Specifically, in the electronic financial transaction processing system 100 of this embodiment, the personal card terminal 110 reads the card information and transmits the read card information to the smart phone 130 in step S290.

In step S292, the smart phone 130 receives the transmitted card information and the transfer or cash withdrawal information, and transmits those information to the ATM device 150 for withdrawal of cash.

In step S294, the cash withdrawal ATM device 150 collects the card information and the transfer or cash withdrawal information transmitted from the smartphone 130, and requests the transfer or the withdrawal of cash to the financial institution server 140.

In step S296, the financial institution server 140 processes the verification of the transfer or the cash withdrawal requested from the ATM device 150 for withdrawal of cash.

If the verification is successful, when it is a cash withdrawal case, the financial institution server 140 instructs the cash withdrawal ATM device 150 to withdraw cash in step S298, and it proceeds to step S310 if it is transfer case in step S308.

That is, in step S300, the cash withdrawal ATM device 150 provides cash according to the cash withdrawal information if the verification is successful and the cash withdrawal instructed by the financial institution server 140, and in step S302, when the message output regarding the cash withdrawal is requested, the message is output in step S304. Then, in step S306, the cash withdrawal ATM device 150 stores the cash payment result and transmits the result to the smart phone 130. In step S310, the financial institution server 140 processes the transfer according to the transfer information. Subsequently, in step S312, the transfer processing result is stored, and the result is transmitted to the smart phone 130.

In step S314, the smartphone 130 receives the transfer or cash withdrawal result from the financial institution server 140 and displays it on the display device.

The configuration and operation of the electronic financial transaction system using the personal ATM terminal according to the present invention have been described in detail with reference to the drawings and the drawings. However, the present invention is not limited to these embodiments, and various changes and modifications are possible. It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### EXPLANATION OF REFERENCE NUMBERS

100: Electronic financial processing system

110: Personal ATM terminal

130: Smartphone

140: Financial institution server

150: ATM device for cash withdrawal

1-10. (canceled)

11. An electronic financial processing system comprising:
a personal ATM (Automated-Teller Machine) terminal storing card information of an electronic financial card and biometric information of a user, if a recognized biometric information matches the stored biometric information, reading a presented card information from a presented electronic financial card, encrypting electronic financial transaction information required for requested electronic financial service and the read card information, and transmitting the encrypted electronic financial transaction information and the encrypted card information;
an communication device connected to the personal ATM terminal via a wired connection or a wireless connection, receiving the electronic financial transaction information from the user, transmitting the received electronic financial transaction information to the personal ATM terminal, receiving the encrypted electronic financial transaction information and the encrypted card information from the personal ATM terminal, and requesting an electronic financial service by transmitting the encrypted electronic financial transaction information and the encrypted card information to a server; and
a financial institution server registering and managing the personal ATM terminal, when the electronic financial service is requested from the communication device, approving the requested electronic financial transaction depending on the electronic financial transaction information.

12. The system of claim 11, wherein the personal ATM terminal comprising:
a storage unit storing the card information of the electronic financial card and the biometric information of the user for a verification;
a communication unit communicating with the communication device via the wired connection or the wireless connection;
a reader unit reading the presented card information from the presented electronic financial card and recognizing the biometric information of the user;
a verification unit verifying an identity of the user and a validity of the electronic financial card by using at least one of the recognized biometric information, the stored biometric information in the storage unit, the presented card information of the electronic financial card and the stored card information;
an encryption unit encrypting data transmitted to the communication device; and
a control unit communicating with the storage unit, the communication unit, the reader unit, the verification unit and the encryption unit and controlling the storage unit, the communication unit, the reader unit, the verification unit and the encryption unit to read the presented card information from the presented electronic financial card, if the recognized biometric information matches the stored biometric information, to encrypt the electronic financial transaction information required for the electronic financial service requested from the communication device and the read card information and to transmit the encrypted electronic financial transaction information and the encrypted card information to the communication device.

13. The system of claim 11, further comprising an ATM device for a cash withdrawal connected to the financial institution server to process the cash withdrawal in cooperation with the financial institution server when the electronic financial service requested by the personal ATM terminal is the cash withdrawal.

14. A method of electronic financial processing for the electronic financial processing system of claim 11 comprising:
recognizing the biometric information of the user;
verifying, by the personal ATM terminal, the identity of the user by comparing the recognized biometric information of the user with the stored biometric information;
reading, by the personal ATM terminal, if the recognized biometric information matches the stored biometric information, the card information of the electronic financial card;
receiving, by the communication device, the electronic financial transaction information required for the electronic financial service from the user;
transmitting, by the communication device, the electronic financial transaction information to the personal ATM terminal;
encrypting, by the personal ATM terminal, the electronic financial transaction information and the card information;
transmitting, by the personal ATM terminal, the encrypted electronic financial transaction information and the encrypted card information to the communication device;
requesting, by the communication device, the electronic financial service to the financial institution server by transmitting the encrypted electronic financial transaction information and the encrypted card information to the financial institution server;
approving, by the financial institution server, the electronic financial service requested by the communication device.

15. The method of claim 14, wherein, when requesting the electronic financial service, at least one of the card information and the electronic financial transaction information for the requested electronic financial service is encrypted by the personal ATM terminal, and at least one of the card information and the electronic financial transaction information is decrypted by the financial institution server.

16. The method of claim 14, further comprising:
identifying, by the personal ATM terminal, a financial institution from the read card information;
generating, by the personal ATM terminal, a card information data through assigning a financial institution code to the read card information wherein the financial institution code corresponds to the identified financial institution; and
transmitting, by the personal ATM terminal, the card information data to the communication device so that the communication device requests the electronic financial service.
transmitting, by the communication device, the card information and at least one of the cash transfer information and the cash withdrawal information to an ATM device for a cash withdrawal connected with the financial institution server;
transmitting, by the ATM device for a cash withdrawal, the card information and at least one of the cash transfer information and the cash withdrawal information to the financial institution server with requesting at least one of a cash transfer and a cash withdrawal to the financial institution server;
processing, by the financial institution server, a verification of at least one of the requested cash transfer and the requested cash withdrawal;
allowing, by the financial institution server, if the verification is successful for the requested cash withdrawal, the user to withdraw a cash from the ATM device according to the cash withdrawal information;
processing, by the financial institution server, if the verification is successful for the requested cash transfer, the requested cash transfer according to the cash transfer information; and
saving, by at least one of the ATM device and the financial institution server, at least one of a cash withdrawal result or a cash transfer result.
